(19) United States
(12) Patent Application Publication
(10) Pub. No.: US 2004/0059616 A1
(43) Pub. Date: Mar. 25, 2004

(54) System and method for managing measurement work flow

(76) Inventors: Chih-Kuang Chang, Tu-Chen (TW); LiHua Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/330,391

(22) Filed: Dec. 27, 2002

(30) Foreign Application Priority Data
Sep. 20, 2002 (TW) 91121532

(51) Int. Cl. G06F 17/60

(52) U.S. Cl. 705/8

(57) ABSTRACT

A system for managing measurement work flow includes a drawing receiving apparatus (30) for obtaining design drawings of objects to be measured, a measuring apparatus (50) for measuring objects and generating measurement data on measured objects, and a managing computer (40). The managing computer includes: a measurement program managing module (401) for querying, writing and storing measurement programs for objects; a measurement assignment managing module (402) for managing measuring tasks, and for assigning various measuring tasks to different measurement operators; a report generating module (403) for generating measurement reports on measured objects based on measurement data generated by the measuring apparatus; a quality control module (404) for checking generated measurement reports, and for modifying measurement programs if there are errors in the measurement reports; and a database (405) comprising a measurement program list (410), a measurement assignment list (420), and a measurement report list (430).

### BACKGROUND OF THE INVENTION

1. Field of the Invention

The present invention relates to a system and method for managing work flow, and particularly to a system and method for managing measurement work procedure.

2. Background of the Invention

In a large enterprise, a work task is usually performed in accordance with a corresponding work flow or procedure. A logical, organized work flow or procedure enhances efficiency. In a manufacturing enterprise, poor work procedure not only retards production efficiency, but also often leads to industrial injury. With the continuing development of computer technology, many systems and methods for work flow management have been developed to increase production efficiency.

An example of a computerized work flow management system is found in U.S. Pat. No. 5,974,392, which discloses a work flow system for task allocation and reallocation. A manager server unit employed by the system divides a work effort into a plurality of tasks, and allocates the tasks to client units. The client units each comprise task execution persons fitted for the respective tasks. The work flow system includes a personnel data file, and a function for allocating tasks to client units. The personnel data file stores personal data on each task execution person, including the person's ability to perform each executable task. The function for allocating tasks to client units allocates tasks based on the personnel data file. The personnel data file is regularly updated based on the results of recently completed tasks.

However, the above-described work flow system for task allocation and reallocation only concerns allocation of tasks in a general work flow. In a manufacturing enterprise, a common task is to measure a variety of objects. In a measurement work flow, the procedure for measuring an object typically involves the use of computer measurement programs. Different measurement operators may generate varying measurement data on the same object using the very same measurement programs. On the other hand, the measurement programs themselves may contain error, or may be flawed when used for measuring certain objects. Thus, a system and method for effectively managing measurement work flow is desired.

### SUMMARY OF THE INVENTION

Accordingly, an object of the present invention is to provide a system for managing measurement work flow, and for improving measurement procedure based on measurement data obtained.

Another object of the present invention is to provide a method for managing measurement work flow, and for improving measurement procedure based on measurement data obtained.

In order to accomplish the above-mentioned objects, the present invention provides a system and method for managing measurement work flow. A preferred embodiment of the system comprises a plurality of drawing receiving apparatuses each for obtaining design drawings of objects to be measured, a plurality of measuring apparatuses each for measuring objects and generating measurement data on measured objects, and a plurality of managing computers. Each managing computer comprises: a measurement program managing module for managing measurement programs for objects, such as querying, writing and storing the measurement programs; a measurement assignment managing module for managing measuring tasks, and for assigning various measuring tasks to different measurement operators; a report generating module for generating measurement reports on measured objects based on measurement data generated by the measuring apparatuses; a quality control module for checking generated measurement reports, and for modifying measurement programs if there are errors in the measurement reports; and a database comprising a measurement program list, a measurement assignment list, and a measurement report list.

A preferred embodiment of the method comprises the steps of: (i) submitting a measurement application sheet to a managing computer; (ii) checking whether the measurement application sheet accords with an actual object to be measured; (iii) obtaining drawings of the object if the measurement application sheet accords with the actual object, and numbering the object; (iv) determining whether there are suitable measurement programs for the object; (v) measuring the object if there are suitable measurement programs, and generating measurement data on the object; and (vi) generating a measurement report on the object based on the measurement data.

### BRIEF DESCRIPTION OF THE DRAWINGS

Other objects, advantages and novel features of the present invention will be drawn from the following detailed description of preferred embodiments of the present invention with the attached drawings, in which:

FIG. 1 is a schematic diagram of hardware infrastructure of a measurement work flow management system in accordance with a preferred embodiment of the present invention;

FIG. 2 is a schematic diagram of software infrastructure of a managing computer of the system of FIG. 1;

FIG. 3 is a flow chart of managing measurement work flow in accordance with a preferred embodiment of the present invention;

FIG. 4 is a flow chart further detailing one step of FIG. 3 regarding designing and writing measurement programs; and

FIG. 5 is a flow chart further detailing another step of FIG. 3 regarding modifying measurement programs.

### DETAILED DESCRIPTION OF PREFERRED EMBODIMENTS OF THE INVENTION

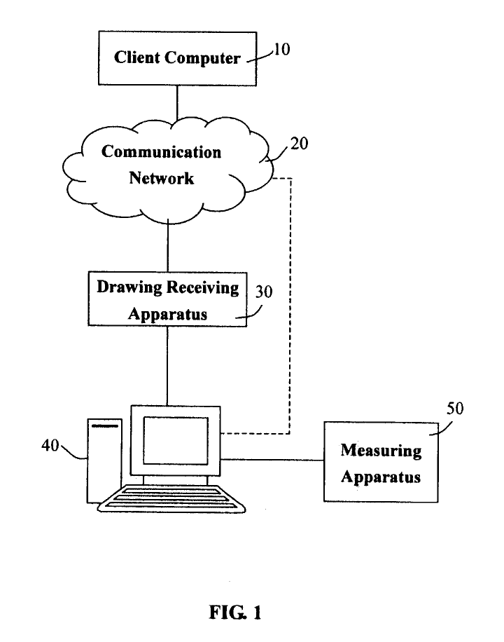

FIG. 1 is a schematic diagram of hardware infrastructure of a measurement work flow management system in accordance with a preferred embodiment of the present invention. The measurement work flow management system comprises a plurality of drawing receiving apparatuses 30, a plurality of managing computers 40, and a plurality of measuring apparatuses 50. For the sake of simplicity, only one drawing receiving apparatus 30, one managing computer 40, and one measuring apparatus 50 are illustrated and detailed for the purposes of describing the preferred embodiment of the present invention. The managing computer 40 is used for managing an entire measurement work flow of an enterprise. The drawing receiving apparatus 30 is connected to the managing computer 40, and is used for obtaining drawings sent from a client computer 10. The drawings are design drawings of objects to be measured. The client computer 10 and the drawing receiving apparatus 30 are linked via a communication network 20. The communication network 20 may be the Internet, or a local area network (LAN). The client computer 10 can also send measurement application sheets to the managing computer 40 via the communication network 20, bypassing the drawing receiving apparatus 30 (as shown by the dashed line in FIG. 1). The measuring apparatus 50 is connected to the managing computer 40, and is used for measuring objects sent by clients. Measurement data generated by the measuring apparatus 50 are sent to and stored in the managing computer 40.

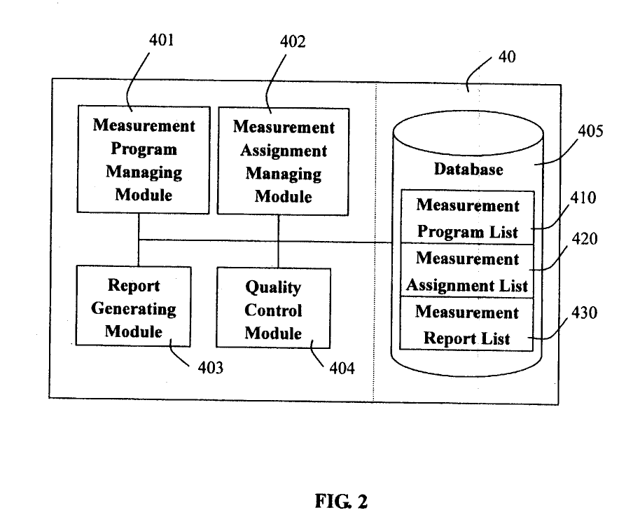

FIG. 2 is a schematic diagram of software infrastructure of the managing computer 40. The software infrastructure comprises a measurement program managing module 401, a measurement assignment managing module 402, a report generating module 403, a quality control module 404, and a database 405. The database 405 comprises a measurement program list 410 for storing various measurement programs for objects to be measured, a measurement assignment list 420 for storing information on measurement operators and measuring tasks of each operator, and a measurement report list 430 for storing measurement reports on objects that have been measured.

The measurement program managing module 401 is used for managing measurement programs for objects, such as querying, writing and storing the measurement programs. In the preferred embodiment of the present invention, different objects are measured by means of different measurement programs. After receiving an object to be measured, an operator queries the measurement program list 410 in the database 405 to determine whether there are suitable measurement programs for the object. If there are no suitable measurement programs, the operator designs and writes measurement programs employing the measurement program managing module 401, and stores the written measurement programs in the measurement program list 410.

The measurement assignment managing module 402 is used for managing measuring tasks, and for assigning various measuring tasks to different measurement operators. When a new measuring task arises, the measurement assignment managing module 402 queries the measurement assignment list 420 to select an operator most suitable for performing the new measuring task. The selected operator may be a person whose schedule allows timely performance, and who has the particular skill and capability needed to accomplish the measuring task well.

The report generating module 403 is used for generating a measurement report on a measured object based on measurement data generated by the measuring apparatus 50, and for storing the generated measurement report in the measurement report list 430. The quality control module 404 is used for checking whether there are errors in measurement reports in the measurement report list 430, and for modifying measurement programs if there are errors in a measurement report.

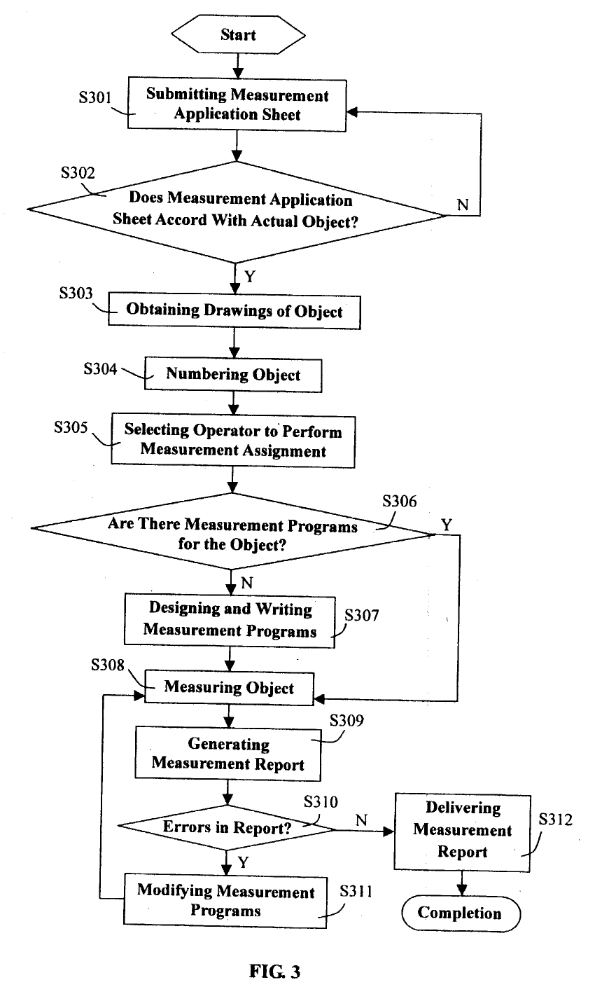

FIG. 3 is a flow chart of managing measurement work flow in accordance with a preferred embodiment of the present invention. When a client wants to measure an object, at step S301, the client submits a measurement application sheet to a measuring department of the enterprise. The client can submit the measurement application sheet to the managing computer 40 of the measuring department via the client computer 10. At the same time, the client delivers the object to the measuring department. At step S302, the measuring department checks whether the measurement application sheet accords with the actual object. If the measurement application sheet does not accord with the actual object, the measuring department rejects the measurement application sheet, and the procedure returns to step S301. If the measurement application sheet accords with the actual object, at step S303, the measuring department obtains drawings of the object by means of the drawing receiving apparatus 30. At step S304, the measuring department numbers the object to ensure systematic managing of all measured objects. Then the measurement assignment managing module 402 queries the measurement assignment list 420 to select a most suitable operator to perform measuring of the object. At step S305, an operator is selected to perform the measurement assignment. At step S306, the operator checks whether there are measurement programs for the object. If there are measurement programs for the object, at step S308, the operator measures the object. If there are no measurement programs for the object, at step S307, the operator designs and writes appropriate measurement programs for the object, and then at step S308 measures the object. After the object has been measured, the measuring apparatus 50 sends measurement data on the object to the managing computer 40. At step S309, the report generating module 403 generates a measurement report on the object based on the measurement data, and stores the generated measurement report in the measurement report list 430 in the database 405. At step S310, the operator checks whether the measurement report has any errors. If the measurement report has one or more errors, at step S311, the operator fills in a measurement error list, and modifies measurement programs so that the object can be re-measured at step S308. If the measurement report does not have any errors, at step S312, the measurement report is delivered to the client.

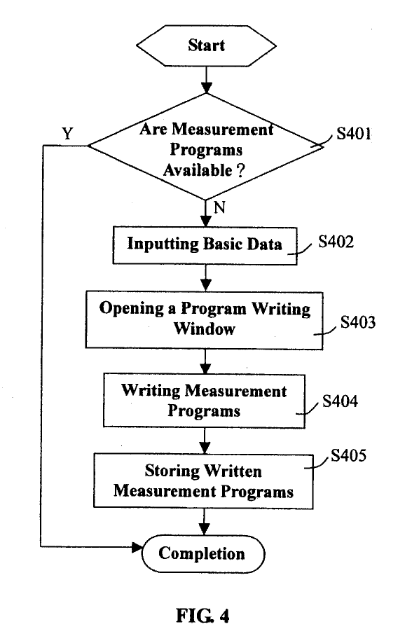

FIG. 4 is a flow chart further detailing step S307 of FIG. 3, in accordance with the preferred embodiment of the present invention. At step S401, the measurement program managing module 401 checks whether there are suitable measurement programs available for the object to be measured, according to a material code of the object. The material code provides a classification of the object. Various classifications of objects have corresponding measurement programs for measuring of objects within the respective classifications. If suitable measurement programs are available, the procedure is completed. If no suitable measurement programs are available, at step S402, an operator inputs basic data on the object. The basic data comprise a client name, a program name and a classification of the object. At step S403, the user opens a program writing window. At step S404, the user designs and writes measurement programs for the object. At step S405, the written measurement programs are stored in the measurement program list 410 in the database 405.

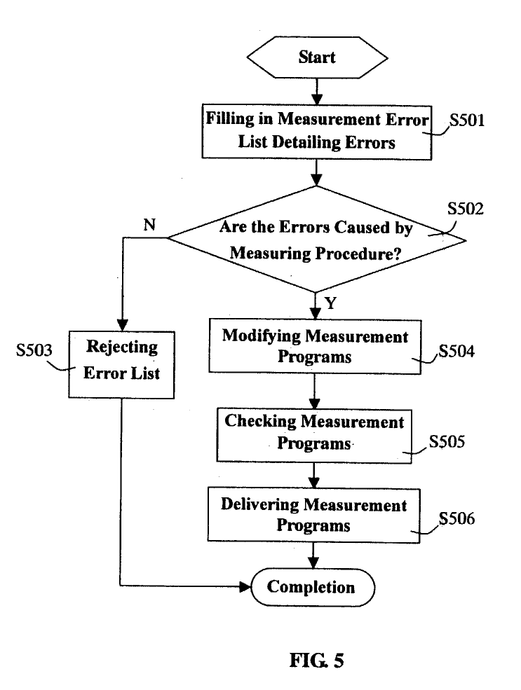

FIG. 5 is a flow chart further detailing step S311 of FIG. 3, in accordance with the preferred embodiment of the present invention. If there are errors in a generated measurement report, at step S501, an operator fills in a measurement error list detailing the errors. At step S502, the quality control module 404 determines whether the errors were caused by a measuring procedure. If the errors were not caused by a measuring procedure, at step S503, the measurement error list is rejected, and the procedure is completed. If the errors were caused by a measuring procedure, at step S504, the operator modifies measurement programs for the object. At step S505, the operator checks the modified measurement programs. At step S506, the modified measurement programs are delivered for re-measuring of the object.

While the present invention has been described above, it should be understood that it has been presented by way of example only and not by way of limitation. Thus the breadth and scope of the present invention should not be limited by the above-described exemplary embodiments, but should be defined only in accordance with the following claims and their equivalents.

What is claimed is:

1. A system for managing measurement work flow, the system comprising:
at least one drawing receiving apparatus for receiving design drawings of objects to be measured;
at least one measuring apparatus for measuring objects and generating measurement data on the objects; and
at least one managing computer comprising:
a measurement program managing module for querying, writing and storing measurement programs for objects;
a measurement assignment managing module for managing measurement tasks, and for assigning various measurement tasks to different measurement operators;
a report generating module for generating measurement reports on measured objects based on measurement data generated by the at least one measuring apparatus; and
a database comprising a measurement program list, a measurement assignment list, and a measurement report list.

2. The system as claimed in claim 1, further comprising a quality control module for checking measurement reports on measured objects, and for modifying measurement programs if there is an error in any measurement report.

3. The system as claimed in claim 1, wherein the measurement program list is used for storing various measurement programs for objects to be measured.

4. The system as claimed in claim 1, wherein the measurement assignment list is used for storing information on operators, and storing tasks of each of the operators.

5. The system as claimed in claim 1, wherein the measurement report list is used for storing reports on objects that have been measured.

6. A method for managing measurement work flow, the method comprising the steps of:
(a) submitting a measurement application sheet to a managing computer;
(b) checking whether the measurement application sheet accords with an actual object to be measured;
(c) receiving drawings of the object if the measurement application sheet accords with the actual object, and numbering the object;
(d) determining whether there are suitable measurement programs for the object;
(e) measuring the object if there are suitable measurement programs, and generating measurement data on the object; and
(f) generating a measurement report on the object based on the measurement data.

7. The method as claimed in claim 6, wherein step (d) further comprises the step of:
designing and writing measurement programs for the object if there are no suitable measurement programs.

8. The method as claimed in claim 6, further comprising the steps of:
checking whether the measurement report has any error;
modifying measurement programs if the measurement report has any error; and
re-measuring the object.

9. A method of managing measurement work flow, comprising steps of:
(1) assigning a qualified personal to measure a specific work piece waiting for being measured;
(2) selecting a proper measuring program for the specific work piece;
(3) executing said measurement program if said program exists, or designing and writing measurement program before executing if said program does not exist;
(4) gathering and examining measurement results;
(5) finalizing said measurement results if no errors are found in said results, or modifying the program and rerunning the program before finalizing said results if errors are found in the result; and
(6) delivering said finalized results.
